(19) United States
(12) Patent Application Publication
(10) Pub. No.: US 2003/0040244 A1
(43) Pub. Date: Feb. 27, 2003

(54) Thermal insulating material formed of non-woven fabric and method of manufacturing the same

(76) Inventors: Toshihiro Yamamoto, Osaka (JP); Toshiharu Yashiro, Osaka (JP); Makio Nagata, Osaka (JP); Noboru Watanabe, Yamaguchi (JP); Hiroshi Onoue, Osaka (JP)

Correspondence Address: BIRCH STEWART KOLASCH & BIRCH, PO BOX 747, FALLS CHURCH, VA, 22040-0747, US

(21) Appl. No.: 09/935,739

(22) Filed: Aug. 24, 2001

(51) Int. Cl. B32B 5/02; B32B 27/04; B32B 27/12; B32B 5/26; B32B 27/02; D04H 1/00; D04H 3/00; D04H 5/00; D04H 13/00

(52) U.S. Cl. 442/415; 442/394; 442/381; 442/392

(57) ABSTRACT

A thermal insulating material is formed by stacking two or more card webs, and each card web includes a matrix fiber, a heat-melting fiber, and a thin film formed by the heat-melting fiber being fused on a surface of the card web. Each card web has the heat-melting fiber within the card web fused together, and the card webs are integrated by fusing of the heat-melting fibers between the card webs. The thermal insulating material is used such that the direction in which the card webs are stacked runs parallel to the direction in which thermal insulation is effected.

### BACKGROUND OF THE INVENTION

1. Field of the Invention

The present invention relates to a thermal insulating material, and more specifically, to a thermal insulating material for housing use using a polyester fiber and the like.

2. Description of the Background Art

In recent years, attempts are made to reduce carbon-dioxide emissions for the purpose of preventing global warming. One of the strategies involves improving the heating and cooling efficiencies of houses. Thus, there is a demand for a thermal insulating material that has higher thermal insulation property that satisfies the standard for energy conservation of the next generation.

International Publication No. WO 99/43903 discloses a thermal insulating material using a fiber. This thermal insulating material is one that has a plurality of card webs stacked one on top of another. A card web includes a polyester fiber, a sheath-core type composite fiber that utilizes a low melting point component for the sheath having a lower melting point than the core, and a fused portion in which these fibers are fused and stuck together by melting of a sheath portion of the sheath-core type composite fiber.

Since the fibers are fused together by the melting of the sheath portion, this thermal insulating material undergoes little change over time in shape and in thermal insulation rate when compared with conventional thermal insulating materials such as glass wool and rock wool. The thermal insulating material can be easily cut in a direction in which card webs are stacked so that it can be easily worked upon at a housing construction site.

The thermal insulating material disclosed in this publication, however, does not sufficiently satisfy the thermal insulation rate based on the standard for energy conservation of the next generation (i.e., high thermal insulation rate means low thermal conductivity). Thus, the thermal insulation rate that satisfies the above-mentioned standard is being achieved by increasing the thickness of a thermal insulating material or by increasing the fiber density of a non-woven fabric forming the thermal insulating material.

When the thickness of the thermal insulating material is increased, the above-mentioned standard may be satisfied, but the cost may increase or the thermal insulating material may no longer conform to the standards of construction materials for house use. When the fiber density of the non-woven fabric forming the thermal insulating material is increased, the above-mentioned standard may be satisfied, but the cost increases.

### SUMMARY OF THE INVENTION

An object of the present invention is to provide a thermal insulating material that achieves high thermal insulation rate and a method of manufacturing such a thermal insulating material without incurring an increase in the cost.

Another object of the present invention is to provide a thermal insulating material that achieves high thermal insulation rate by effectively blocking airflow and a method of manufacturing such a thermal insulating material.

A further object of the present invention is to provide a thermal insulating material that achieves high thermal insulation rate using fiber and a method of manufacturing such a thermal insulating material.

A still further object of the present invention is to provide a thermal insulating material that utilizes fiber and that does not deform easily and a method of manufacturing such a thermal insulating material.

An even further object of the present invention is to provide a thermal insulating material suitable for a wall surface of a house and a method of manufacturing such a thermal insulating material.

According to one aspect of the present invention, the thermal insulating material is made of non-woven fabric including multiple types of fiber. The thermal insulating material includes a matrix fiber, a heat-melting fiber, and a thin film formed by the heat-melting fiber being fused at a surface of the thermal insulating material.

The matrix fiber and the heat-melting fiber are entangled. Thus, very small air gaps are formed inside the thermal insulating material, while at the same time, it becomes less easy for the overall shape of the thermal insulating material to undergo deformation. Air is held in the air gaps, thereby achieving thermal insulation effect. A surface of the thermal insulating material is heated to form a thin film in which the heat-melting fibers on the surface are fused and stuck together. The thin film blocks the flow of air held within the thermal insulating material and increases the thermal insulation effect even further. As a result, a thermal insulating material that achieves high thermal insulation rate can be provided without incurring the increase in the cost.

According to the above one aspect of the present invention, the thermal insulating material has two or more card webs, each including multiple types of fiber, stacked one on top of another. Each card web includes a matrix fiber, a heat-melting fiber, and a thin film formed by the heat-melting fiber being fused on a surface of the card web. Each card web has heat-melting fibers fused together within the card web, and the card webs are integrated by fusing and sticking together of the heat-melting fibers.

The heat-melting fiber on a surface of a card web forms a thin film on each of the surfaces of the two or more card webs being stacked. The heat-melting fiber inside a card web integrates the card web. The heat-melting fibers between card webs integrate the card webs. Consequently, a thin film formed on a surface of a card web blocks the flow of air that exists inside the two or more card webs, thereby increasing the thermal insulation effect even further. Through the integration of the card webs, it becomes less easy for the overall shape of the thermal insulating material to undergo deformation. As a result, a thermal insulating material that achieves high thermal insulation rate can be provided without incurring the increase in the cost.

More preferably, the thermal insulating material according to the above one aspect of the present invention does not conduct heat easily in a direction the card webs are stacked.

The heat-melting fiber forms a thin film on a surface of a card web. Since the direction in which card webs are stacked runs parallel to the direction in which thermal insulation is effected, the thin film formed on the surface of a card web blocks the flow of air that exists within two or more card webs, thereby making it less easy for heat to conduct in the direction in which the card webs are stacked. By using this thermal insulating material for a wall surface of housing, for instance, heat is not easily conducted from indoors to outdoors, and vice versa.

According to another aspect of the present invention, a method of manufacturing a thermal insulating material includes the steps of mixing a matrix fiber with a heat-melting fiber, forming the mixed fibers into a card web, and heating a surface of the card web to fuse the heat-melting fiber on the surface of the card web to form a thin film on the surface of the card web.

A card web is formed in which the matrix fiber and the heat-melting fiber are mixed. The matrix fiber and the heat-melting fiber are entangled so that very small air gaps are formed inside the thermal insulating material. Air is held in the air gaps, thereby achieving thermal insulation effect. In a succeeding step, a surface of the card web is heated so that the heat-melting fiber on the surface of the card web is fused, thereby forming a thin film on the surface of the card web. The thin film blocks the flow of air held within the thermal insulating material and increases the thermal insulation effect even further. These manufacturing steps can be performed using a manufacturing apparatus arranged for the conventional manufacturing steps. As a result, a thermal insulating material that achieves high thermal insulation rate can be manufactured without incurring the increase in the cost.

According to a further aspect of the present invention, a method of manufacturing a thermal insulating material is a method of manufacturing a thermal insulating material in which two or more card webs, each including multiple types of fiber, are stacked. This manufacturing method includes the steps of mixing a matrix fiber with a heat-melting fiber, forming the mixed fibers into a card web, heating a surface of the card web to fuse the heat-melting fiber on the surface of the card web to form a thin film on the surface of the card web, stacking two or more card webs having undergone heat treatment in the step of forming the thin film, and fusing the heat-melting fiber inside the two or more card webs stacked and fusing the heat-melting fibers between the card webs to integrate the card webs.

A card web is formed in which the matrix fiber and the heat-melting fiber are mixed. In the step of heating the surface of the card web, the heat-melting fiber on a surface of the card web fuses together and forms a thin film the surface of the card web. In the step of stacking the card webs, the card webs are stacked. When the stacked card webs are heated, the heat-melting fibers inside and between card webs are fused. The stacked card webs are integrated. Consequently, the thin film formed on the surface of the card webs blocks the flow of air that exists inside the card webs, thereby increasing the thermal insulation effect even further. With the two or more card webs being integrated, it becomes less easy for the overall shape of the thermal insulating material to undergo deformation. These manufacturing steps can be performed using a manufacturing apparatus arranged for the conventional manufacturing steps. As a result, a thermal insulating material that achieves high thermal insulation rate can be manufactured without incurring the increase in the cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a step of manufacturing a non-woven fabric thermal insulating material according to a first embodiment of the present invention.

FIGS. 2 and 3 are diagrams related to the description of usage of a stack thermal insulating material according to a second embodiment of the present invention.

FIG. 4 is a diagram in the form of a table showing the properties of the stack thermal insulating material according to the second embodiment of the present invention.

### DESCRIPTION OF THE PREFERRED EMBODIMENTS

The embodiments of the present invention will be described below with reference to the drawings. In the following description and throughout the drawings, the same parts are denoted by the same reference characters. The names and the functions thereof are also the same. Thus, the detailed descriptions thereof will not be repeated.

### First Embodiment

A non-woven fabric thermal insulating material according to the first embodiment of the present invention will be described below. First, the fiber forming the non-woven fabric thermal insulating material will be described.

In a case where synthetic fiber is employed as the matrix fiber forming the non-woven fabric thermal insulating material, the polymer is not limited to any particular type. For instances aromatic polyester such as polyethylene terephthalate and polybutylene terephthalate, aliphatic polyester such as polylactic acid and polycaprolactam, polyolefin such as polypropylene and polyethylene, polyamide such as Nylon 6 and Nylon 66, and copolymer thereof may be used. In addition, a mixture of two or more types of these fibers may also be used.

In order efficiently to recycle the thermal insulating material, a polymer of polyester-type is more preferred. As a polyester fiber, polyethylene terephthalate, polyhexamethylene terephthalate, polytetramethylene terephthalate, poly 1,4-dimethylcyclohexane terephthalate, polyhydrolactone, or copolymerized esters thereof may be used. A composite fiber thereof produced by conjugate spinning may also be used. A side-by-side composite fiber made of two kinds of polymers having different heat shrinkage rates is preferred since it develops a three-dimensional structure due to spiral crimp. In this case, a hollow fiber having hollowness of 5 to 30 percent is particularly preferred.

Preferably, the fineness of the matrix fiber is 1 to 30 dtex and its cut length is 25 to 150 mm.

A synthetic fiber is used as the heat-melting fiber forming the non-woven fabric thermal insulating material. In this case, the polymer is not limited to any particular type; For instance, aromatic polyester such as polyethylene terephthalate and polybutylene terephthalate, aliphatic polyester such as polylactic acid and polycaprolactam, polyolefin such as polypropylene and polyethylene, polyamide such as Nylon 6 and Nylon 66, and copolymer thereof may be used. In addition, a mixture of two or more types of these fibers may also be used.

The heat-melting fiber may be a single-constituent fiber formed from any one of the above-described polymers. The heat-melting fiber may also be sheath-core type composite fiber. In this case, a usual polyester fiber constituent is used for the core, while low melting-point polyester, polyolefin, polyamide or the like is used for the sheath. The core component and the sheath component are combined such that the difference between the melting points of the core component and the sheath component becomes 30° C. or greater. By using such composite fiber, heat-fusing feature can be achieved while retaining the form-maintaining feature of the core component. Since the overall shape of the thermal insulating material would not be easily deformed, it is particularly preferable when it is to be used for a long period of time as in the case of the thermal insulating material. Preferably, the fineness of the heat-melting fiber is 2 to 20 dtex and its cut length is 25 to 76 mm.

The card web used for the non-woven fabric thermal insulating material according to the first embodiment is preferably one obtained by mixing a matrix fiber and a heat-melting fiber at a weight ratio of 95 through 40 to 5 through 60.

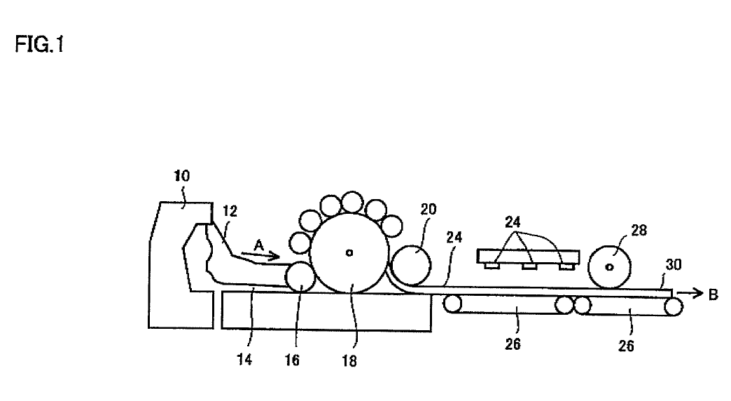

The non-woven fabric thermal insulating material according to the first embodiment is produced by subjecting to a first heat treatment with far infrared rays and the like, a card web obtained by mixing a matrix fiber with a sheath-core composite fiber that utilizes a low melting point component for the sheath having a lower melting point than the core. The first heat treatment forms a thin film on a surface of the card web. The detail of this manufacturing method will be described below with reference to FIG. 1.

An apparatus for manufacturing the thermal insulating material includes a hopper 10 for opening and mixing the matrix fiber and the heat-melting fiber, a conveyor belt 14 for transporting the mixed fiber mixture 12, a feed roller 16 for guiding, to a carding machine, fiber mixture 12 transported by conveyor belt 14, a cylinder roller 18 for carding and forming fiber mixture 12 into a web, and a doffer 20 for transporting outward a card web 22 carded by cylinder roller 18. As it moves toward the direction of an arrow A, fiber mixture 12 is processed to form card web 22.

The apparatus further includes a transporting conveyor 26 for transporting card web 22 including the matrix fiber and the heat-melting fiber, a heater 24 disposed opposite to transporting conveyor 26 for heating a surface of card web 22, and a cooling roller 28 provided on the exit side of heater 24 for cooling card web 22 as well as compressing card web 22 to a prescribed thickness. As it moves toward the direction of an arrow B, card web 22 is processed to form a non-woven fabric thermal insulating material 30.

Heater 24 may be any heater that can heat a surface of card web 22, and is not limited to any particular type. Heater 24 effects non-uniform heat treatment from a surface of card web 22 toward the direction of the thickness of card web 22. Heater 24 fuses the heat-melting fiber on the surface to form a thin film on the surface of card web 22. For instance, an infrared heater may be used as such heater 24. Indirect heating by radiant heat of the infrared heater is effected from one side of card web 22, In this case, the radiant heat does not reach into the central portion in the direction of thickness of card web 22 and to the back side of card web 22 so that the temperatures thereat do not rise. Thus, the degree of fusion becomes gradually lower. In this manner, the thin film is formed only on the surface.

Heater 24 may be a hot plate or a heating roller that is brought into contact with card web 22. A thin film can be formed on a surface of card web 22 using such a hot plate or a heating roller.

The heating temperature achieved by heater 24 (the surface temperature of card web 22) is preferably in a range of 110 to 220° C., A temperature within this temperature range is sufficient to melt the polymer of the heat-melting fiber on the surface to form a thin film, and affects the matrix fiber only a little. Thus, changes in physical properties and the like caused by polymer degradation according to heat history to which the matrix fiber is subjected can be suppressed.

In the first heat treatment, the quantity of heat that card web 22 receives can be changed so as to vary the degree of melting of the heat-melting fiber. The feed speed in the direction of arrow B of the card web can be changed to vary the heating time and thus the degree of the melting.

Non-woven fabric thermal insulating material 30 produced by the manufacturing apparatus described above may be used by itself as a thermal insulating material, or a plurality of non-woven fabric thermal insulating materials 30 may be stacked and used as the thermal insulating material. The thin film formed on a surface of non-woven fabric thermal insulating material 30 blocks the flow of air contained in non-woven fabric thermal insulating material 30, thereby achieving high thermal insulation effect.

As described above, in the non-woven fabric thermal insulating material according to the first embodiment, a thin film can be formed on a surface of the non-woven fabric by the first heat treatment. This thin film can block the flow of air within the thermal insulating material. No special apparatus is required in order to form the thin film. Consequently, a thermal insulating material that achieves high thermal insulation rate can be provided without incurring the increase in the cost.

### Second Embodiment

A stack thermal insulating material according to the second embodiment of the present invention will be described below. A fiber forming the stack thermal insulating material according to the second embodiment is the same as that which forms the non-woven fabric thermal insulating material according to the first embodiment. Thus, the detailed descriptions thereof will not be repeated here.

The stack thermal insulating material according to the second embodiment is manufactured by stacking one on top of another a plurality of non-woven fabric thermal insulating materials 30 produced by performing the first heat treatment in the first embodiment. A manufacturing apparatus for the stack thermal insulating material includes a stacking machine and a second heat treatment machine in addition to the manufacturing apparatus of the first embodiment. The stacking machine stacks a plurality of non-woven fabric thermal insulating materials 30 having undergone the first heat treatment to form a stack body. The second heat treatment machine performs a second heat treatment to the stack body and fuses the heat-melting fiber inside each non-woven fabric thermal insulating material 30 and the heat-melting fibers between the plurality of non-woven fabric thermal insulating materials 30. Details of the manufacturing apparatus will be described below.

A prescribed number (ten sheets to twenty sheets) of non-woven fabric thermal insulating materials 30, each produced to have a prescribed weight per unit area, a prescribed density, and a prescribed shape by the first heat treatment, are stacked to form a stack body.

The stack body is held under compression between plates such as metal plates having good thermal conduction property, and is erected in an upright condition and subjected to heat treatment within a steam pot. Then, the stack body while held under compression is rotated by 90 degrees and is subjected to heat treatment such that the load does not affect the stack body in a direction of its thickness.

In the second heat treatment, conditions of the heat treatment is determined such that sufficient heat reaches inside the stack body so as to fuse together the heat-melting fiber within the stack body and to fuse the heat-melting fibers between non-woven fabric thermal insulating materials 30. In particular, the conditions of the heat treatment is determined such that the thin film formed on a surface of non-woven fabric thermal insulating material 30 by the first heat treatment is maintained.

By subjecting the stack body to heat treatment while holding it under compression, a repulsion force in the horizontal direction (direction opposite to the direction of compression) is created in the fiber inside the stack body. Consequently, moving of the fiber toward the lower part of the thermal insulating material due to the self-weight of the fiber can be prevented. The second heat treatment is preferably performed by introducing steam of 98 kPa or greater into the steam pot after having lowered the pressure inside the steam pot to 100 kPa or greater. A plate used for holding the stack body under compression is preferably a perforated plate.

By performing the second heat treatment, a stack body of a desired density can be manufactured regardless of the thickness of the stack body. For instance, even when the weight per unit area of card web 22 and the number of card webs to be stacked are the same, a product of low density can be produced by not compressing the card webs too strongly during heat treatment, while a product of high density can be produced by compressing the card webs strongly during heat treatment. Even with a thick stack body having a thickness of 1000 mm, for example, fusing of the heat-melting fiber inside can be uniformly effected. Using the above-described manufacturing apparatus, an excellent product with an overall fine hand and feel can be efficiently manufactured. A product of a desired density with a density variation in the range of within ±5 percent can be easily manufactured.

By performing such second heat treatment, a stack thermal insulating material according to the second embodiment can be manufactured. In the stack thermal insulating material manufactured, a plurality of non-woven fabric thermal insulating materials 30 are stacked, and the heat-melting fiber is fused inside the stack thermal insulating material, while a thin film is formed on a surface of each non-woven fabric thermal insulating material 30 inside the stack thermal insulating material.

In addition, when manufacturing the stack thermal insulating material according to the second embodiment, the second heat treatment can be performed by rotating the stack body such that its weight is not localized in one direction.

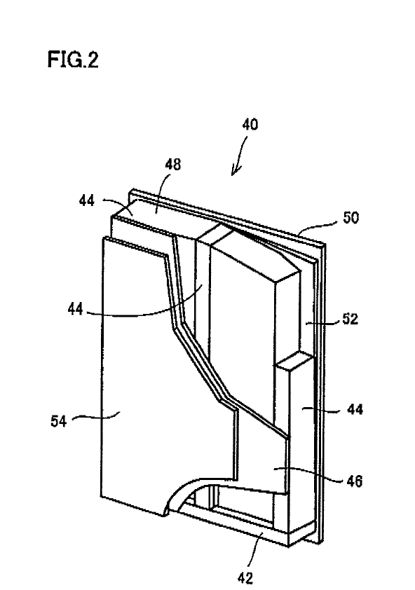

A usage of the stack thermal insulating material of the second embodiment will be described with reference to FIG. 2. A wall panel 40 for housing use in which the stack thermal insulating material of the second embodiment is used includes a framework assembled by horizontal frames 42 and vertical frames 44, an exterior board element 46 provided on the exterior side of the framework, an interior board element 50 provided on the interior side of the framework, a stack thermal insulating material 48 inserted in the inner space of the framework, a moisture-proof sheet 52 provided between interior board element 50 and stack thermal insulating material 48, and an exterior member 54.

The components of the framework are produced by lumber and bonded wood. The lumber is blocks of wood having cross sections of 50.8 mm×101.6 mm (2 inches×4 inches), 50.8 mm×152.4 mm (2 inches×6 inches), and so on based on various standards. A thickness of thermal insulating material 48 is determined according to the dimension of the wood block. An interval between vertical frames 44 positioned on panel 40 is normally 455 mm from center to center, but may be changed according to a structural requirement. Horizontal frames 42 include an upper frame as well as the lower frame being shown.

A structural plywood having a thickness of about 7 to 12 mm and the like may be used as exterior board element 46, and a plasterboard having a thickness of about 9 to 15 mm and the like may be used as interior board element 50.

The apparent thickness of stack thermal insulating material 48 according to the second embodiment is about 90 mm matching the width of the framework (a thickness of horizontal frame 42 or vertical frame 44). Stack thermal insulating material 48 is inserted into the framework to make complete contact with moisture-proof sheet 52 mentioned above as well as with exterior board element 46. In other words, it is constructed such that stack thermal insulating material 48 completely fills the space between the walls formed by the framework members.

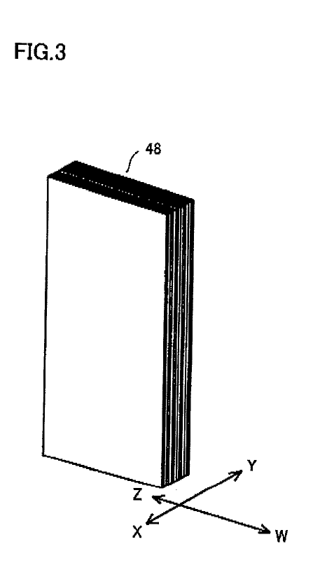

As shown in FIG. 3, when stack thermal insulating material 48 is used, it is preferable that the direction in which non-woven fabric thermal insulating materials 30 are stacked runs parallel to the direction of the wall thickness (direction in which thermal insulation is to be effected). In this manner, the thin film formed on the surface of non-woven fabric thermal insulating material 30 blocks the airflow in the directions of heat insulation (directions indicated by an arrow X-Y).

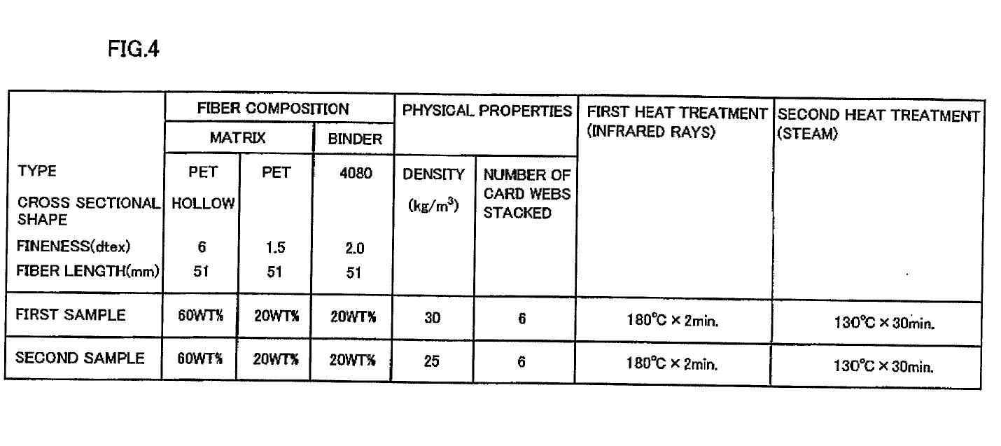

FIG. 4 shows the properties of the stack thermal insulating material according to the second embodiment. The first and second heat treatment were performed on card webs having a fiber composition shown in FIG. 4 and stack thermal insulating materials (first sample, second sample) were produced.

Thermal conductivity in an X-Y direction and in a Z-W direction in FIG. 3 was measured with regard to the stack thermal insulating material manufactured under the above-described conditions shown in FIG. 4. The measuring method according to “JIS A 1412-1994 Test Methods for Thermal Transmission Properties of Thermal Insulations, 5.1 Plate Direct Method” was employed.

As a result of the measurement, the thermal conductivity in the XY direction of the first sample was 0.038 (W/m·mK) and the thermal conductivity in the ZW direction of the first sample was 0.042 (W/m·K), while the thermal conductivity in the XY direction of the second sample was 0.039 (W/m·K) and the thermal conductivity in the ZW direction of the second sample was 0.044 (W/m·K). Both the first and second samples were found to satisfy a rank C (0.040 to 0.035 (W/m·K)) of the standard for energy conservation of the next generation.

As described above, in addition to the effects obtained by the first heat treatment, the non-woven fabric thermal insulating material according to the second embodiment achieves through the second heat treatment uniform fusing inside a card web forming the non-woven fabric thermal insulating material, which eliminates variation in density so that a non-woven fabric thermal insulating material with an overall fine hand and feel and superior external appearance can be provided. The second heat treatment effects fusing between card webs forming the non-woven fabric thermal insulating material so that a plurality of card webs can be integrated. As a result, the thermal insulating material that achieves high thermal insulation rate can be provided without incurring the increase in the cost.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A thermal insulating material made of non-woven fabric including multiple types of fiber, comprising:
a matrix fiber;
a heat-melting fiber; and
a thin film formed by said heat-melting fiber being fused on a surface of said thermal insulating material.

2. A thermal insulating material having two or more card webs, each including multiple types of fiber, stacked one on top of another, wherein
each of said card webs includes
a matrix fiber,
a heat-melting fiber, and
a thin film formed by said heat-melting fiber being fused on a surface of each of said card webs,
each of said card webs having said heat-melting fibers fused together within the card web, and
said card webs being integrated by fusing of said heat-melting fibers.

3. The thermal insulating material according to claim 2, which does not conduct heat easily in a direction said card webs are stacked.

4. A method of manufacturing a thermal insulating material, comprising the steps of:
mixing a matrix fiber with a heat-melting fiber;
forming mixed fibers into a card web; and
heating a surface of said card web to fuse the heat-melting fiber on the surface of said card web to form a thin film on the surface of said card web.

5. A method of manufacturing a thermal insulating material in which two or more card webs) each including multiple types of fiber, are stacked, comprising the steps of:
mixing a matrix fiber with a heat-melting fiber;
forming mixed fibers into a card web;
heating a surface of said card web to fuse said heat-melting fiber on the surface of said card web to form a thin film on the surface of said card web;
stacking two or more of said card webs having undergone heat treatment in the step of forming said thin film; and
fusing the heat-melting fiber inside said two or more card webs stacked and fusing the heat-melting fiber between said card webs to integrate said card webs.
